(19) United States
(12) Patent Application Publication
(10) Pub. No.: US 2008/0272695 A1
(43) Pub. Date: Nov. 6, 2008

(54) Lamp capsule retainer

(75) Inventors: Gilbert N. Misiaszek, Hillsboro, NH (US); Joseph L. Wegman, Henniker, NH (US); Edward P. Otto, Henniker, NH (US); William L. Kretovic, Concord, NH (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/800,174

(22) Filed: May 4, 2007

(51) Int. Cl. H01J 61/12

(52) U.S. Cl. 313/570

(57) ABSTRACT

A lamp assembly (10) comprising: a lamp (20) having a glass envelope (22) containing a gaseous fill at a pressure greater than atmospheric pressure and a seal (24) comprising a substantially parallelepipedonal structure having two oppositely disposed long sides (26, 28) and two oppositely disposed short sides (30, 32); and a retainer (50) engaging the seal (24), the retainer (50) including four pressure points (52), two on each of the long sides (26, 28) with an indent separating each pair of the long side pressure points.

### TECHNICAL FIELD

This invention relates to automotive headlamps and more particularly to such headlamps employing a light source in a glass envelope containing a gaseous fill at a pressure greater than normal atmospheric pressure.

### BACKGROUND ART

Single filament tungsten halogen, replaceable light sources have been used in the auto industry for forward lighting since at least 1984. The light source capsules are composed of glass containing an atmosphere at a relatively high pressure, for example, greater than 4500 torr, and are mounted in retainers that are subsequently mounted with a socket to form the lamp unit. Under some conditions the pressurized light sources have been known to become damaged in application, handling or in processing, thus creating defects that can propagate over time to generate a crack in the glass envelope, resulting in a chip, fracture or a containment failure. While these defects and possible failures in light sources have never been great (on the order of 50 ppm), nevertheless, it can result in costly corrections.

### DISCLOSURE OF INVENTION

It is, therefore, an object of the invention to obviate the disadvantages of the prior art.

Another object of the invention is the creation of a more stable, pressurized light source.

These objects are accomplished, in one aspect of the invention, by the provision of a lamp assembly comprising: a lamp having a glass envelope containing a gaseous fill at a pressure greater than atmospheric pressure and a seal comprising a substantially parallelepipedonal structure having two oppositely disposed long sides and two oppositely disposed short sides; and a retainer engaging the seal, the retainer including four pressure points, two on each of the long sides. There are four pressure points per retainer half or a total of eight on the press, four on one side of the press and four on the other.

It has been discovered that equalizing the pressure points on the seal where it is engaged by the retainer eliminates the previous problem of occasionally having capsules that fail containment.

### BRIEF DESCRIPTION OF THE DRAWINGS

FIGS. 1 and 2 are elevational views of a lamp that can be used with the invention;

FIG. 3 is a perspective view of one half of a prior art retainer;

FIG. 4 is a diagrammatic plan view of the stress areas of a prior art lamp and retainer;

FIG. 5 is a perspective view of a retainer half in accordance with an embodiment of the invention;

FIG. 6 is a diagrammatic plan view of the stress areas of lamp employing the retainer of FIG. 5;

FIG. 7 is perspective view of a retainer in accordance with a second embodiment of the invention; and

FIG. 8 is a diagrammatic plan view of the stress areas of lamp employing the retainer of FIG. 7.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

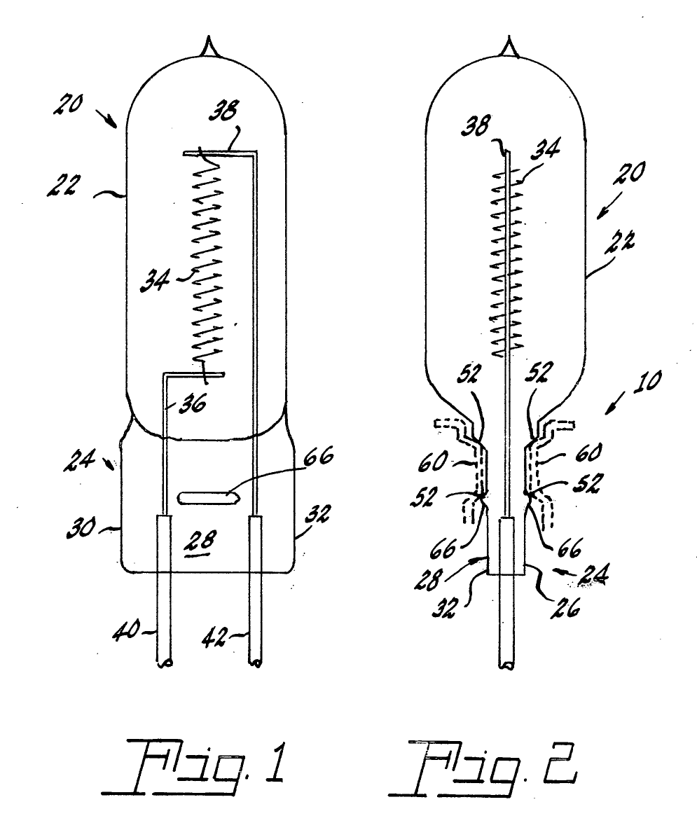

Referring now to the drawings with greater particularity, shown in FIGS. 1 and 2 is a lamp 20 having a glass envelope 22 and a press seal 24. The press seal 24 comprises a substantially parallelepipedonal structure (rectangular in cross-section) having two oppositely disposed long sides 26, 28 and two oppositely disposed short sides 30, 32. A filament 34 is supported within the envelope 22 by supports 36 38 attached to lead-ins 40 42 that are sealed in the press seal 24. Lock protuberances 66 are formed on the long sides 26 and 28.

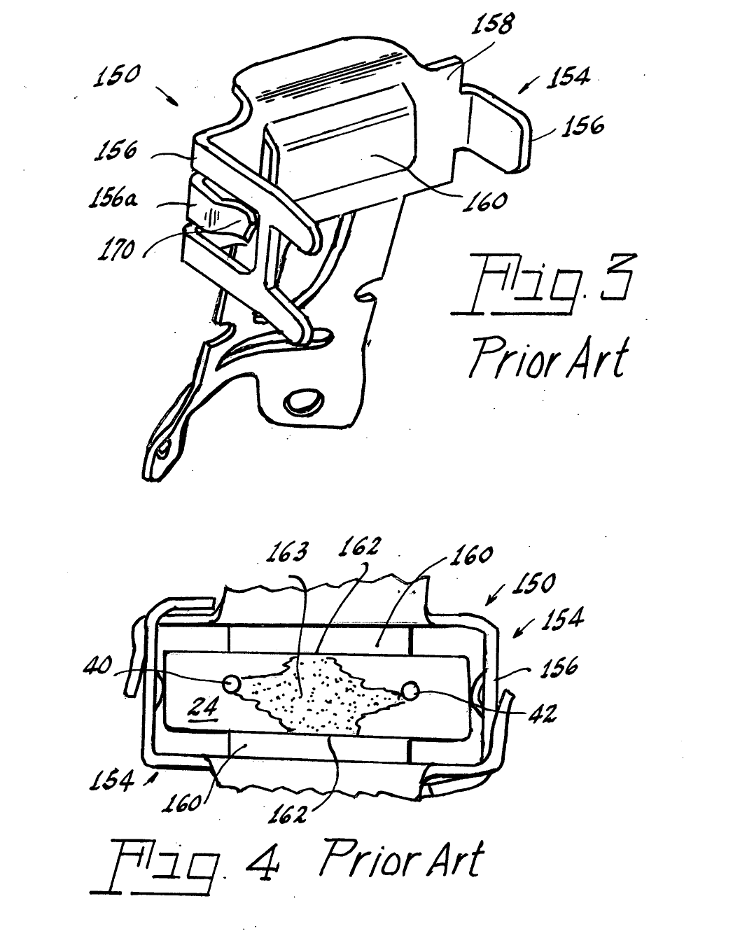

Referring now to FIG. 3 there is shown one half of a prior art retainer 150. Each half comprised a U-shaped member 154 having legs 156 and a bight 158. When two halves are mated they form a configuration that matches the cross-section of the press seal 24, as shown in FIG. 4. A protrusion 160 on the bight of each half formed essentially four pressure points 162, two on either side of the press seal 24 when the halves were assembled by placing two retainers against the seal 24 with the protrusions 160 contacting the long sides 26, 28 of the seal and bending the legs 156 at right angles to secure the two halves together. Dimples 170 on legs 156a contacted the short sides of the seal 24. This construction created a stress area 163 as shown by the dotted section in FIG. 4 and this concentration of stress occasionally contributed to the failure of the press or lamp.

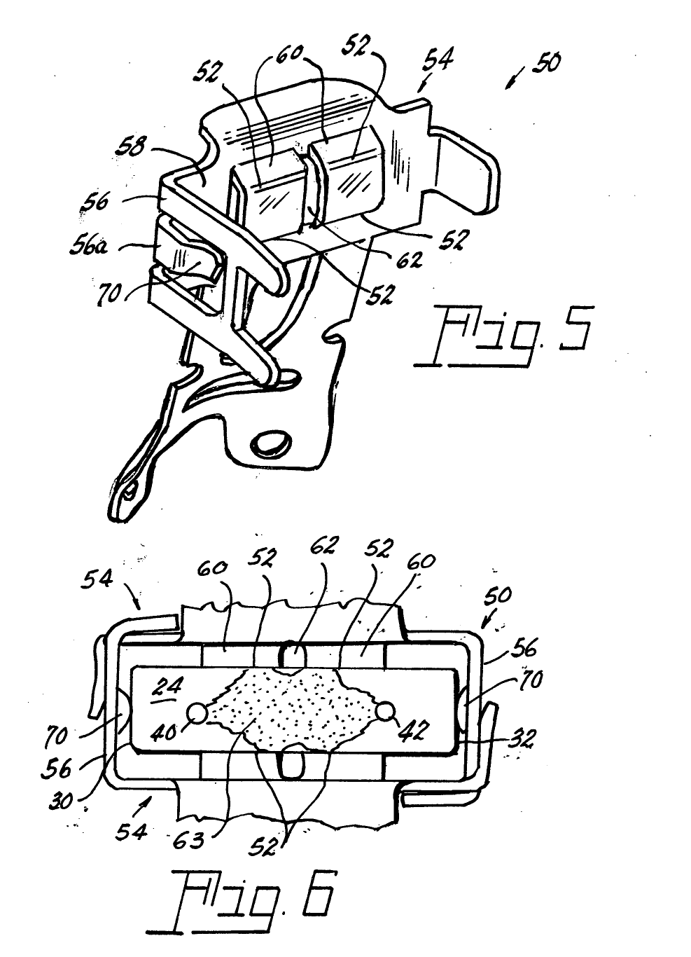

To remedy this condition a retainer 50 is provided to distribute the stress more evenly. A first embodiment of such a retainer 50 is shown in FIG. 5 wherein the retainer comprises a pair of U-shaped members 54 having legs 56 and a bight 58. The protrusions 60 formed on the bights provide four pressure points 52 (two on each protrusion 60). In the embodiment shown in FIG. 5 the four pressure points are formed by separating the protrusions 60 into separate areas by removing the center portion as a cutout 62. This construction separates and distributes the stress area 63 as shown in FIG. 6.

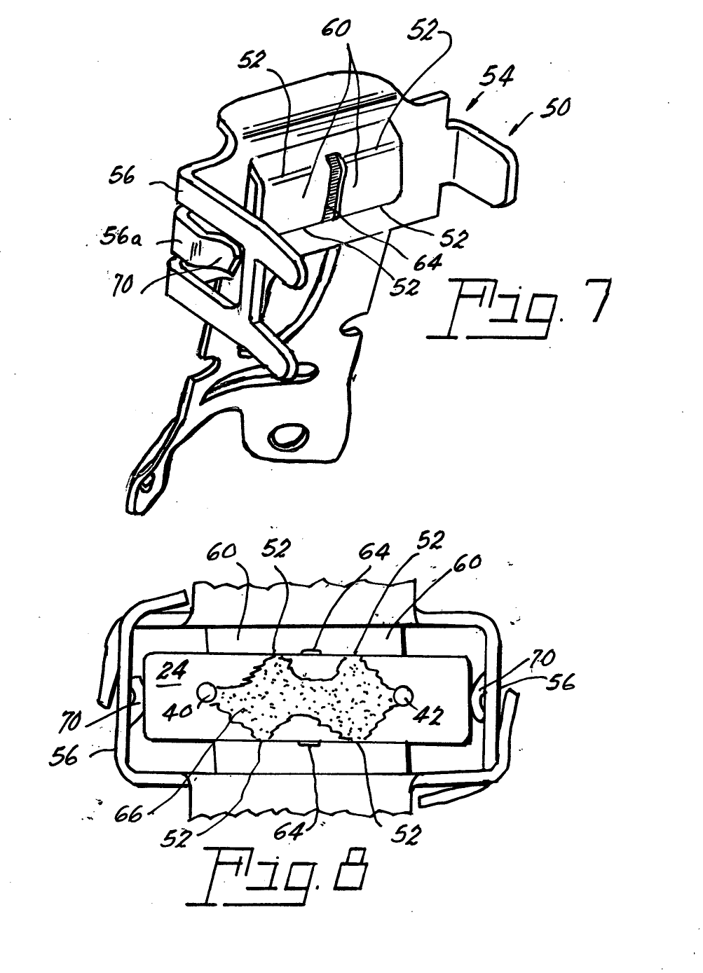

In a preferred embodiment of the invention, shown in FIGS. 7 and 8, the four pressure points 52 are formed by a coined region 64 on the protrusion 60, which provides the resultant stress area 66 seen in FIG. 8. The coined design of FIGS. 7 and 8 is preferred from an aesthetic perspective.

During assembly, two retainers 50 are placed against the press seal 24 with the protrusions 60 engaging the long sides 26, 28 of the seal 24. Dimples 70 formed on one of the legs 56a engage the short sides 30, 32 and the legs 56 are bent substantially at right angles to hold the two retainers in position.

The protrusions 60 are captured between the lock protuberances 66 and the bottom of the envelope 22, as shown in phantom lines in FIG. 2, thus fixing the envelope in both lateral directions as well as the vertical or longitudinal direction.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A lamp assembly comprising:
a lamp having a glass envelope containing a gaseous fill at a pressure greater than atmospheric pressure and a seal comprising a substantially parallelepipedonal structure having two oppositely disposed long sides and two oppositely disposed short sides; and
a retainer engaging said seal, said retainer including four pressure points, two of said pressure points engaging each of said long sides of said seal.

2. The lamp assembly of claim 1 wherein said retainer comprises a pair of U-shaped members each having legs and a bight mated to form a configuration matching said seal, each bight of said pair of U-shaped members providing adjacently two of said pressure points.

3. The lamp assembly of claim 2 wherein said two adjacent pressure points comprise protrusions extending from said bight with a cutout therebetween.

4. The lamp assembly of claim 2 wherein said two adjacent pressure points comprise protrusions extending from said bight with a coined area therebetween.

5. The lamp assembly of claim 1 wherein said seal includes lock protuberances on said oppositely disposed long sides and said pressure points engage said seal at a position on said seal between said envelope and said lock protuberances.
